(19) United States
(12) Patent Application Publication
(10) Pub. No.: US 2018/0260703 A1
(43) Pub. Date: Sep. 13, 2018

(54) SYSTEMS AND METHODS FOR TRAINING NEURAL NETWORKS

(71) Applicant: Massachusetts Institute of Technology, Cambridge, MA (US)

(72) Inventors: Marin Soljacic, Belmont, MA (US); Yichen Shen, Cambridge, MA (US); Li Jing, Cambridge, MA (US); Tena Dubcek, Zagreb (HR); Scott Skirlo, Belmont, MA (US); John E. Peurifoy, Cambridge, MA (US); Max Erik Tegmark, Winchester, MA (US)

(73) Assignee: Massachusetts Institute of Technology, Cambridge, MA (US)

(21) Appl. No.: 15/820,906

(22) Filed: Nov. 22, 2017

Related U.S. Application Data
(60) Provisional application No. 62/434,539, filed on Dec. 15, 2016.
(60) Provisional application No. 62/425,420, filed on Nov. 22, 2016.

(51) Int. Cl. G06N 3/08; G06N 3/04; G06F 17/14; G06F 17/16

(52) U.S. Cl. CPC G06N 3/08; G06F 17/16; G06F 17/142; G06N 3/0445

(57) ABSTRACT

A system for training a neural network model, the neural network model comprising a plurality of layers including a first hidden layer associated with a first set of weights, the system comprising at least one computer hardware processor programmed to perform: obtaining training data; selecting a unitary rotational representation for representing a matrix of the first set weights, the selected unitary rotational representation comprising a plurality of parameters; training the neural network model using the training data using an iterative neural network training algorithm to obtain a trained neural network model, each iteration of the iterative neural network training algorithm comprising: updating values of the plurality of parameters in the selected unitary rotational representation for representing the matrix of the set of weights for the at least one hidden layer, and saving the trained neural network model.

### CROSS REFERENCE TO RELATED APPLICATIONS

This application claims the benefit under 35 U.S.C. § 119(e) of U.S. Provisional Application Ser. No. 62/425,420, entitled “GENERAL UNITARY NEURAL NETWORK” filed on Nov. 22, 2016 and of U.S. Provisional Application Ser. No. 62/434,539, entitled “GENERAL UNITARY NEURAL NETWORK” filed on Dec. 15, 2016, each of which is incorporated by reference herein in its entirety.

### FEDERALLY SPONSORED RESEARCH

This invention was made using Government support under Grant No. W911NF-13-D-0001 awarded by the Army Research Office. The Government has certain rights in the invention.

### FIELD

Aspects of the technology described herein relate to techniques for improving machine learning systems. Some aspects relate to techniques for training neural networks by using unitary rotational representations to avoid vanishing and exploding gradient problems that plague conventional neural networks, thereby limiting their applicability.

### BACKGROUND

Recently, machine learning systems based on neural network models have been successfully applied to a variety of tasks including image recognition, speech recognition, and natural language processing. Examples of such neural network models include recurrent neural networks (RNNs) and deep neural networks (e.g., convolutional neural networks). A recurrent neural network takes an input sequence and uses the current hidden state to generate a new hidden state during each step, memorizing past information in the hidden layer.

Neural networks are trained using iterative optimization algorithms, such as gradient descent or stochastic gradient descent, which involve iteratively updating neural network parameters. Iteratively updating neural network parameters may involve updating the parameters of the neural network in proportion of the gradient of the error function with respect to these parameters.

### SUMMARY

Some embodiments are directed to a novel class of neural networks in which weight matrices associated with hidden layers are represented using respective unitary rotational representations developed by the inventors. Using such representations allows the vanishing gradient and exploding gradient problems, which plague conventional neural networks, to be avoided. When applied to recurrent neural networks, the techniques enable recurrent neural networks to learn long-term correlations in data. The techniques may also be applied to other types of neural networks, including deep neural networks such as convolutional neural networks.

The unitary rotational representations developed by the inventors allow for the parameters in the representation to be updated with very low computational complexity—merely O(1) per parameter. In addition, the unitary rotational representations are tunable—they may represent weight matrices in either a selected subspace of the space of unitary matrices or the whole space of unitary matrices, which provides for added flexibility to trade off accuracy and computational complexity.

Some embodiments are directed to a method for training a neural network model, the neural network model comprising a plurality of layers including a first hidden layer associated with a first set of weights, the method comprising using at least one computer hardware processor to perform: obtaining training data; selecting a unitary rotational representation for representing a matrix of the first set weights, the selected unitary rotational representation comprising a plurality of parameters; training the neural network model using the training data using an iterative neural network training algorithm to obtain a trained neural network model, each iteration of the iterative neural network training algorithm comprising: updating values of the plurality of parameters in the selected unitary rotational representation for representing the matrix of the set of weights for the at least one hidden layer; and saving the trained neural network model.

Some embodiments are directed to at least one non-transitory computer-readable storage medium storing processor-executable instructions that, when executed by at least one computer hardware processor, cause the at least one computer hardware processor to perform a method for training a neural network model, the neural network model comprising a plurality of layers including a first hidden layer associated with a first set of weights, the method comprising: obtaining training data; selecting a unitary rotational representation for representing a matrix of the first set weights, the selected unitary rotational representation comprising a plurality of parameters; training the neural network model using the training data using an iterative neural network training algorithm to obtain a trained neural network model, each iteration of the iterative neural network training algorithm comprising: updating values of the plurality of parameters in the selected unitary rotational representation for representing the matrix of the set of weights for the at least one hidden layer; and saving the trained neural network model.

Some embodiments are directed to a system for training a neural network model, the neural network model comprising a plurality of layers including a first hidden layer associated with a first set of weights, the system comprising: at least one computer hardware processor; and at least one non-transitory computer-readable storage medium storing processor-executable instructions that, when executed by the at least one computer processor, causes the at least one computer processor to perform: obtaining training data; selecting a unitary rotational representation for representing a matrix of the first set weights, the selected unitary rotational representation comprising a plurality of parameters; training the neural network model using the training data using an iterative neural network training algorithm to obtain a trained neural network model, each iteration of the iterative neural network training algorithm comprising: updating values of the plurality of parameters in the selected unitary rotational representation for representing the matrix of the set of weights for the at least one hidden layer, and saving the trained neural network model.

In some embodiments, selecting the unitary rotational representation comprises selecting a tunable span unitary rotational representation for representing the matrix of the first set of weights. In some embodiments, selecting the tunable span unitary rotational representation comprises: selecting a subspace of the space of unitary matrices; and selecting a unitary rotational representation corresponding to the selected subspace.

In some embodiments, selecting the unitary rotational representation comprises selecting an FFT-based unitary rotational representation.

In some embodiments, the weight matrix is an N×N matrix and the FFT-based unitary rotational representation comprises a product of log(N) pairwise rotation matrices.

In some embodiments, the neural network model is a recurrent neural network model.

In some embodiments, the neural network model is a deep neural network model.

In some embodiments, the selected unitary rotational representation comprises a product of rotation matrices, and wherein the plurality of parameters comprises angle parameters of the rotation matrices.

In some embodiments, the training data comprises a plurality of training inputs and corresponding class labels, and wherein the processor-executable instructions further cause the at least one computer hardware processor to perform: obtaining new data not part of the training data; applying the new data as input to the trained neural network model to obtain corresponding output; and assigning a class label to the new data based on the corresponding output.

In some embodiments, the plurality of layers includes a second hidden layer associated with a second set of weights different from the first set of weights, wherein the processor-executable instructions further cause the at least one computer hardware processor to perform: selecting a second unitary rotational representation for representing a matrix of the set of weights, the selected second unitary rotational representation comprising a second plurality of parameters different from the plurality of parameters.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

Various non-limiting embodiments of the technology will be described with reference to the following figures. It should be appreciated that the figures are not necessarily drawn to scale.

FIG. 1 is an illustrative diagram of a recurrent neural network model.

FIG. 2A is an illustrative diagram of rotation matrix, in accordance with some embodiments of the technology described herein.

FIG. 2B is an illustrative diagram of a rotational representation of a unitary matrix, in accordance with some embodiments of the technology described herein.

FIG. 2C is an illustrative diagram of another rotational representation of a unitary matrix, in accordance with some embodiments of the technology described herein.

FIG. 3 is a flowchart of an illustrative process 300 for training a neural network model using one or more unitary rotational representations for a respective one or more weight matrices, in accordance with some embodiments of the technology described herein.

FIG. 4 illustrates the performance of neural network models, which were trained in accordance with some embodiments described herein, on a copying task.

FIG. 5 illustrates the performance of neural network models, which were trained in accordance with some embodiments described herein, on a handwriting recognition task.

FIG. 6 illustrates the performance of neural network models, which were trained in accordance with some embodiments described herein, on a speech prediction task.

FIG. 7 is a diagram of an illustrative computer system that may be used in implementing some embodiments of the technology described herein.

### DETAILED DESCRIPTION

The inventors have developed techniques for improving conventional machine learning systems that use neural networks. Conventional neural networks are difficult to train because they suffer from vanishing and exploding gradient problems. The severity of these problems increases with the depth of (number of hidden layers in) a neural network. As a result, these problems are particularly pronounced for deep neural networks and recurrent neural networks (RNNs), whose recurrence in some instances may be equivalent to thousands or millions of equivalent hidden layers.

In practical terms, the vanishing and exploding gradient problems preclude the application of neural networks to certain types of tasks because they make it impossible to train neural networks for such tasks. For example, the vanishing and exploding gradient problems make it difficult or impossible for neural networks to learn long-term correlations in data, which is critical in certain applications such as, for example, speech recognition and natural language processing. Indeed, in these applications, modeling long-term correlations is very important because data earlier in the data stream (e.g., an earlier portion of an audio waveform, an earlier portion of text, etc.) can provide information about the content of data later in the data stream (e.g., a later portion of the audio, a later portion of text, etc.). Taking advantage of such long-term correlations can significantly improve the performance of speech recognition and/or natural language processing systems.

Accordingly, some embodiments are directed to techniques for directly overcoming the vanishing and exploding gradient problems for neural networks. The techniques developed by the inventors not only directly address these problems, but do so using a flexible and computationally-efficient approach as described herein. Using the techniques developed by the inventors, neural networks can be trained with depths not previously attainable using conventional methods. As one example, recurrent neural networks may be trained to model long-term correlations. As a result, the neural network techniques developed by the inventors constitute a direct improvement of conventional machine learning technology, which is a computer-related technology. The improvement is both in terms of broadening the applicability of machine learning technology to a wider set of tasks and implementing the machine learning technology in a more computationally efficient way thereby improving the operation (memory usage, processor usage) of computers implementing such machine learning systems. For example, the techniques developed by the inventors improve conventional neural network training techniques by reducing the amount of processing power and memory required to train neural networks, thereby dramatically improving the performance of computer systems used to perform said training.

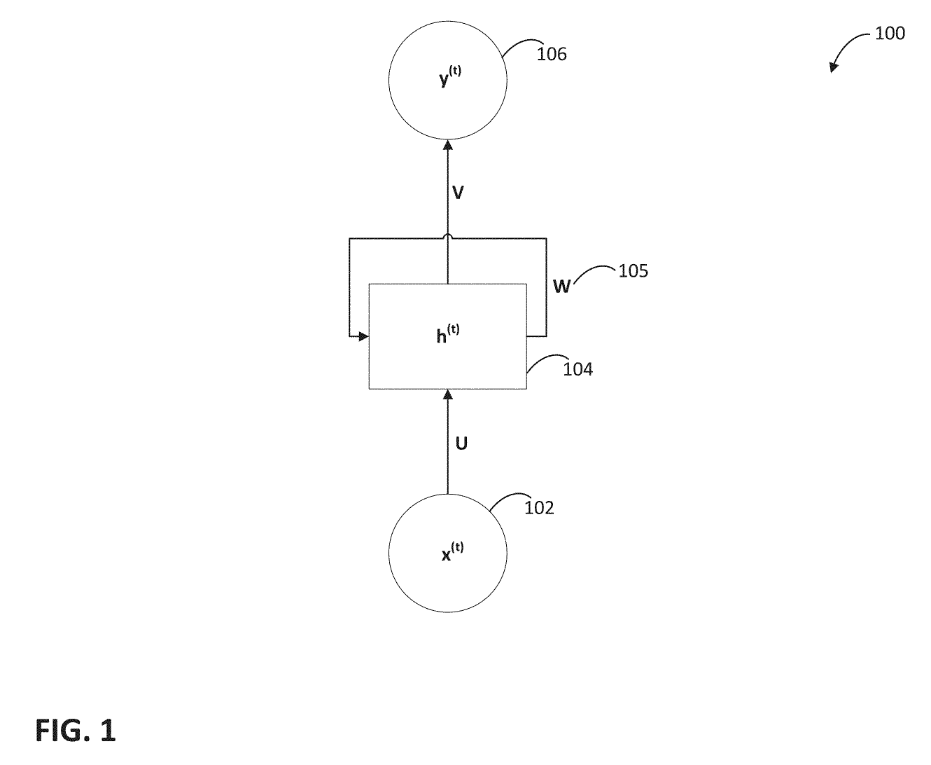

To further illustrate the vanishing and exploding gradient problems, consider the recurrent neural network (RNN) 100 illustrated in FIG. 1. The RNN 100 has an input layer 102, a hidden layer 104, and an output layer 106. The RNN 100 is updated at regular time intervals t=1, 2, 3 . . . . The input of the RNN 100 is the sequence of vectors x(t) (a scalar or vector-valued time-series) whose hidden layer h^{(t)} is updated according to the following rule:

h^{(t)}=σ(Ux^{(t)}+Wh^{(t-1)}),

where σ is the nonlinear activation function. The weight matrix W is shown using reference numeral 105 in FIG. 1. The output of the RNN 100 is generated by

y^{(t)}=Vh^{(t)}+b,

where b is the bias vector for the hidden-to-output layer. For t=0, the hidden layer h(0) may be initialized to some special vector or set as a trainable variable. For convenience of notation, we define z^{(t)}=Ux^{(t)}+Wh^{(t-1)} so that h^{(t)}=σ(z^{(t)}).

When training the recurrent neural network 100 to minimize a cost function C that depends on a parameter vector a, the gradient descent method updates this vector to

$$a - λ \frac{\partial C}{\partial a} ,$$

where λ is a fixed learning rate and

$$\frac{\partial C}{\partial a} ≡ ∇ C .$$

For a recurrent neural network, the vanishing or exploding gradient problem is most significant during back propagation from hidden to hidden layers. Training the input-to-hidden and hidden-to-output matrices is relatively trivial once the hidden-to-hidden matrix has been successfully optimized.

In order to evaluate the gradient for the hidden layers

$$\frac{\partial C}{\partial {W}_{ij}} ,$$

one first computes derivative

$$\frac{\partial C}{\partial {h}^{( t )}}$$

using the chain rule:

$$\frac{\partial C}{\partial {h}^{( t )}} = \frac{\partial C}{\partial {h}^{( T )}} \frac{\partial {h}^{( T )}}{\partial {h}^{( t )}} = \frac{\partial C}{\partial {h}^{( T )}} {\prod }_{k = t}^{T - 1} \frac{\partial {h}^{( k + 1 )}}{\partial {h}^{( k )}} = \frac{\partial C}{\partial {h}^{( T )}} {\prod }_{k = t}^{T - 1} {D}^{( k )} W ,$$

where D^{(k)}=diag{α′(Ux^{(k)}+Wh(k⁻¹)} is the Jacobian matrix of the pointwise nonlinearity. For large times T, the term H W plays a significant role. As long as the eigenvalues of D^{(k)} are of order unity, then if W has eigenvalues λᵢ>1, they will cause gradient explosion

$$\vert \frac{\partial C}{\partial {h}^{( T )}} \vert \to ∞$$

(i.e., the gradient explosion problem) due to the magnitude of ΠW growing, while if W has eigenvalues λᵢ<<1, they can cause gradient vanishing,

$$\vert \frac{\partial C}{\partial {h}^{( T )}} \vert \to 0$$

(i.e., the gradient vanishing problem) due to the magnitude of ΠW shrinking. Either situation prevents the recurrent neural network from being trained efficiently or at all!

The inventors have recognized and appreciated that conventional approaches to solving the vanishing and exploding gradient problems are insufficient and can be improved upon. For example, in the context of recurrent neural networks, long short-term memory (LSTM) neural networks were proposed in an attempt to control the vanishing and exploding gradient problems. LSTMs contain information inside hidden layers with gates. Other proposed approaches include bidirectional recurrent neural networks and gated recurrent unit (GRU) recurrent neural networks. However, none of these approaches directly addresses the vanishing and exploding gradient problems—they just try to control the effects. In many cases, the attempt to control the effect of vanishing and exploding gradients falls short and gradient clipping is required to keep the gradient values in a reasonable range (not too small and not too large).

Other conventional approaches address the vanishing and exploding gradient problems by restricting the weight matrices of the neural networks to be orthogonal or unitary matrices (the complex generalization of orthogonal matrices). Since the eigenvalues of such matrices have absolute values of unity, they can be raised to large powers (e.g., as may be required during calculation of gradients during backpropagation). However, the conventional approaches to restricting the weight matrices to be orthogonal or unitary are computationally expensive.

Moreover, in the case of unitary matrices, these conventional approaches do not allow for the selection of a unitary subspace that is suitable for the task at hand. Either the entire space of unitary matrices is used (which requires a lot of computation and introduces many more parameters than needed to solve particular problems) or a particular fixed subspace is selected (to allow for tractable computation) without providing a choice of which subspace is best to use for a particular task.

For example, one conventional approach to restricting the weight matrices to be unitary, involves simply updating a weight matrix W with standard backpropagation and then projecting the resulting matrix (which will typically no longer be unitary) onto the space of unitary matrices. This method is referred to herein as the projective full-space unitary recurrent neural network (PURNN) technique. Defining

$${G}_{ij} ≡ \frac{\partial C}{\partial {W}_{ij}}$$

as the gradient with respect to W, this can be implemented as follows:

$${A}^{( t )} ≡ {G}^{{( t )}^{†}} {W}^{( t )} - {W}^{{( t )}^{†}} {G}^{( k )} , \\ {W}^{( t + 1 )} ≡ {( I + \frac{λ}{2} {A}^{( t )} )}^{- 1} ( I - \frac{λ}{2} {A}^{( t )} ) {W}^{( t )} .$$

However, this approach is computationally expensive (and therefore impractical or infeasible) for many applications) because when using this approach, performing back-propagation requires performing N-dimensional matrix multiplication, incurring [symbol] (N³) computational cost.

Another conventional approach to restricting the weight matrices to be unitary is to restrict them to be a specific unitary matrix subspace, where computations may be performed more efficiently than in the PURNN technique. This method is referred to herein as a partial space unitary recurrent neural network (URNN). In this approach, the hidden-to-hidden matrix of a recurrent neural network is parametrized in the following unitary form:

W=D₃T₂ [symbol] ⁻¹D₂ΠT₁ [symbol] D₁.

In this parameterization, the matrices D_{1,2,3} are diagonal matrices with each element e^{iwj}, j=1, 2, . . . , n. T_{1,2} are reflection matrices, and

$$T = I - 2 \frac{\hat{v} {\hat{v}}^{†}}{{‖ \hat{v} ‖}^{2}} ,$$

where \hat{v} is a vector with each of its entries as a parameter to be trained. Π is a fixed permutation matrix. [symbol] and [symbol] ⁻¹ are Fourier and inverse Fourier transform matrices respectively. Since each matrix in the factorization here is unitary, the product W is also a unitary matrix. (Note this representation does not include any rotation matrices, unlike the unitary rotational representations developed by the inventors). This model uses [symbol] (N) parameters, which spans merely a part of the whole [symbol] (N²)-dimensional space of unitary N×N matrices, which allows for more efficient computation than the PURNN technique. However, this approach is still computationally expensive and also restricts the weight matrices to be in a specific subspace of unitary matrices, which cannot be selected/altered by the user, limiting the applicability and flexibility of this approach. The inventors have recognized and appreciated that both of these conventional approaches for restricting weight matrices to be unitary may be improved upon.

Some embodiments of the technology described herein address some of the above-discussed drawbacks of conventional techniques for training neural network models. However, not every embodiment addresses every one of these drawbacks, and some embodiments may not address any of them. As such, it should be appreciated that aspects of the technology described herein are not limited to addressing all or any of the above discussed drawbacks of conventional techniques for training neural network models.

The inventors have developed novel techniques for training neural network models in which weight matrices of the neural network model are restricted to be unitary through the use of one or more of the novel unitary rotational representations developed by the inventors. This directly addresses the vanishing gradient and exploding gradient problems. The unitary rotational representations developed by the inventors are tunable in that their parameters may be set to alter the span of the subspace of unitary matrices spanned by the unitary rotational representation. Importantly, these unitary rotational representations are amenable for extremely fast calculations, which allows for these representations to be used for training neural network models much more efficiently (both in terms of processor and memory resources) than previously possible with conventional methods.

Accordingly, in some embodiments, a neural network having a hidden layer associated with a set of weights may be trained by: (1) obtaining training data; (2) selecting a unitary rotational representation for representing a matrix of the first set weights, the selected unitary rotational representation comprising a plurality of parameters; (3) using the training data and an iterative neural network training algorithm (e.g., gradient descent, stochastic gradient descent, or any other suitable iterative optimization algorithm) to obtain a trained neural network model, each iteration of the iterative neural network training algorithm including updating values of the plurality of parameters in the selected unitary rotational representation for representing the matrix of the set of weights for the at least one hidden layer; and (4) saving the trained neural network model (e.g., by saving the values of the parameters of the neural network model including the values of the plurality of parameters of the selected unitary rotational representation).

In some embodiments, the selected unitary rotational representation may be composed of a product of multiple rotation matrices, which are unitary by definition (hence the nomenclature of a “unitary rotational representation”). The parameters of the selected unitary rotational representation may include the parameters of rotation matrices in the product. For example, the parameters may include angle parameters of the rotation matrices (e.g., the angles θᵢⱼ φᵢⱼ described below for rotation matrices Rᵢⱼ).

In some embodiments, the neural network may be a recurrent neural network, a deep neural network, or any other neural network having at least one set of weights that may be represented using a square weight matrix (or a rectangular weight matrix as discussed in more detail below).

In some embodiments, the selected unitary rotational representation may be a tunable span unitary rotational representation. Details of this type of unitary rotational representation are described in more detail below including with reference to Equation 2. Importantly, the tunable span unitary rotational representation may be configured (through the parameter “L” as detailed below) to span a particular desired subspace of the spaces of unitary matrices. Accordingly, in some embodiments, selecting a unitary rotational representation may involve: (1) selecting a particular subspace of the space of unitary matrices (e.g., by selecting the parameter “L”); and (2) obtaining a unitary rotational representation corresponding to the selected subspace (e.g., by constructing a unitary rotational representation using the selected value of “L”).

In some embodiments, an FFT-based unitary rotational representation may be used. Accordingly, in some embodiments, selecting the unitary rotational representation comprises selecting an FFT-based unitary rotational representation. In the FFT-based unitary rotational representation, an N×N weight matrix may be represented as a product of log(N) pairwise rotation matrices. Details of this type of unitary rotational representation are described in more detail below including with reference to Equation 3.

In some embodiments, a trained neural network (trained in accordance with the training techniques described herein) may be applied to new data that was not part of the training data. In some embodiments, a trained neural networks may be applied to a classification task. For example, the trained neural network may have been trained to perform a classification task by being trained with training data that includes multiple training inputs and corresponding class labels. In such instances, the trained neural network may be applied to new data (not part of the original training data). The new data may be applied as input to the trained neural network to obtain corresponding output and a class label may be assigned to the new data based on the corresponding output.

It should be appreciated that some neural networks may have multiple sets of weights, each of which may be collected in a weight matrix that can be represented by a corresponding unitary rotational representation. For example, a neural network may have multiple hidden layers, and each of the hidden layers may be associated with a respective set of weights. Each of the sets of weighs may be collected in a corresponding weight matrix that can be represented by a respective unitary rotational representation. In some embodiments, different weight matrices for different hidden layers may be represented using the same type of unitary rotational representation. In other embodiments, different weight matrices for different hidden layers may be represented using different types of unitary rotational representations, as aspects of the technology described herein are not limited in this respect.

It should be appreciated that the techniques introduced above and discussed in greater detail below may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

### Unitary Matrix Representations

The inventors have appreciated that any N× N unitary matrix W_{N} (e.g., a weight matrix in a neural network) may be represented as a product of rotation matrices {Rᵢⱼ} and a diagonal matrix D, such that W_{N}=DΠᵢ₌₂^{N}Πⱼ₌₁ⁱ⁻¹Rᵢⱼ, where Rᵢⱼ is defined as the N-dimensional identity matrix with the elements Rᵢᵢ, Rᵢⱼ, Rⱼᵢ and Rⱼⱼ replaced as follows:

$$( \begin{matrix}{R}_{ii} & {R}_{ij} \\ {R}_{ji} & {R}_{jj}\end{matrix} ) = ( \begin{matrix}{e}^{i {φ}_{ij}} cos {θ}_{ij} & - {e}^{i φ ij} sin {θ}_{ij} \\ sin {θ}_{ij} & cos {θ}_{ij}\end{matrix} ) .$$

where θᵢⱼ and ϕᵢⱼ are unique (angle) parameters corresponding to Rᵢⱼ. Each of these matrices performs a U(2) unitary transformation on a two-dimensional subspace of the N-dimensional Hilbert space, leaving an (N−2)-dimensional subspace unchanged. In other words, a series of U(2) rotations may be used to successively make all off-diagonal elements of the given N× N unitary matrix zero. This is a generalization generalizes the factorization of a 3D rotation matrix into 2D rotations parametrized by the three Euler angles.

To provide intuition for how this works, let us briefly describe a simple way of doing this that is similar to Gaussian elimination by finishing one column at a time. The unitary matrix W_{N} is multiplied from the right by a succession of unitary matrices R_{Nj} for j=N−1, . . . , 1. Once all elements of the last row except the one on the diagonal are zero, this row will not be affected by later transformations. Since all transformations are unitary, the last column will then also contain only zeros except on the diagonal:

$${W}_{N} {R}_{N , N - 1} {R}_{N , N - 2} … {R}_{N , 1} = ( \begin{matrix}{W}_{N - 1} & 0 \\ 0 & {e}^{iwN}\end{matrix} )$$

The effective dimensionality of the matrix W_{N} is thus reduced to N−1. The same procedure can then be repeated N−1 times until the effective dimension of W_{N} is reduced to 1, leaving us with a diagonal matrix:¹ Note that Gaussian Elimination would make merely the upper triangle of a matrix vanish, requiring a subsequent series of rotations (complete Gauss-Jordan Elimination) to zero the lower triangle. No such subsequent series of rotations is necessary because W is unitary (if a unitary matrix is triangular, it must be diagonal).

W_{N}R_{N,N-1}R_{N,N-2} . . . R_{i,j}R_{i,j-1} . . . R_{3,1}R_{2,1}=D,

where D is a diagonal matrix whose diagonal elements are e^{iwj}, from which the direct representation of W_{N} may be written as:

W_{N}=DR_{2,1}⁻¹R_{3,1}⁻¹ . . . R_{N,N-2}⁻¹=DR_{2,1}′R_{3,1}′ . . . R_{N,N-2}′R_{N,N-1}′. (Equation 1)

where

Rᵢⱼ′=R(−θᵢⱼ,−ϕᵢⱼ)=R(θᵢⱼ,ϕᵢⱼ)⁻¹=Rᵢⱼ⁻¹.

This parametrization thus involves N (N−1)/2 different θᵢⱼ-values, N (N−1)/2 different ϕᵢⱼ-values and N different wᵢ-values, combining to N² parameters in total and spans the entire unitary space. Note we can always fix a portion of our parameters, to span only a subset of unitary space—indeed, our benchmark test below will show that for certain tasks, full unitary space parametrization is not necessary or perhaps even undesirable.

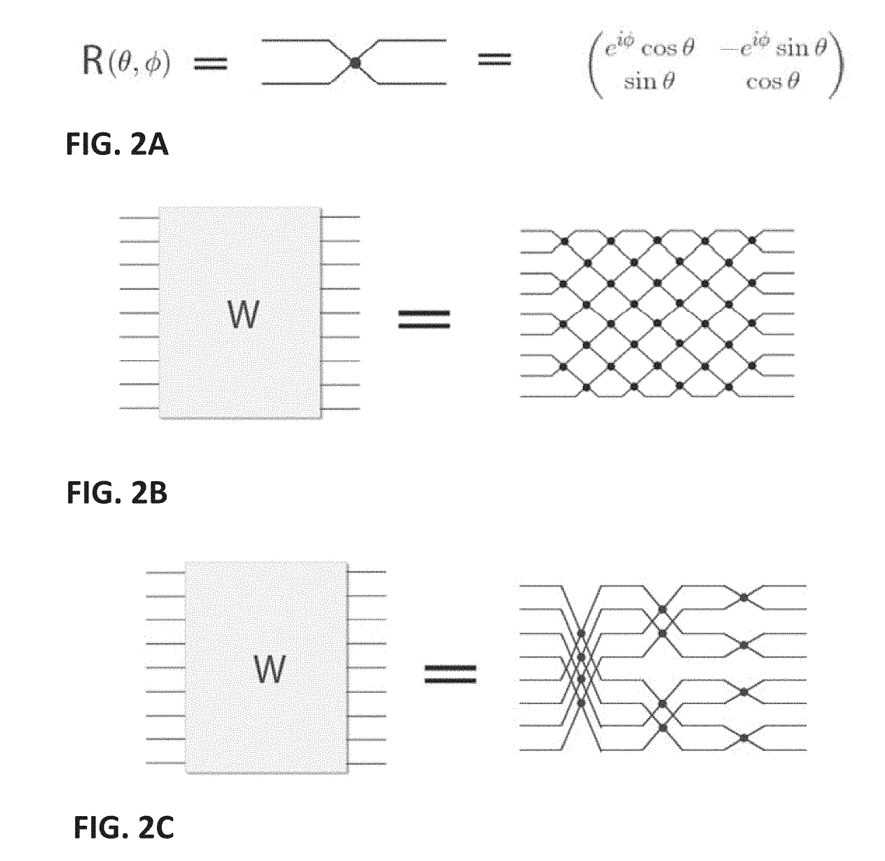

FIGS. 2A-2C show that any arbitrary unitary matrix W can be decomposed into a product of unitary rotation matrices R(θᵢⱼ,ϕᵢⱼ) and a diagonal matrix and a diagonal matrix D. FIG. 2A shows the matrix R(θᵢⱼ,ϕᵢⱼ) and its graphical representation (showing the rotation between two coordinates). FIG. 2B shows how a square unitary matrix W can be decomposed as a series of unitary rotation matrices—each junction in the decomposition of FIG. 2B representing a respective particular rotation matrix (i,j) shown in FIG. 2A. The place of junction in the decomposition graph indicates the indices for the particular rotation matrix used. FIG. 2C shows another way in which the square unitary matrix W can be decomposed as a series of unitary rotation matrices. This particular decomposition is the basis for the FFT-based unitary decomposition described in more detail below.

It should be appreciated that the two decomposition schemes illustrated in FIGS. 2B and 2C are illustrative, and many other decomposition schemes are possible. Indeed, other ways of ordering the rotation matrices are possible, all of which result in corresponding unitary rotational representations that are computationally efficient to implement as discussed in more detail below.

### Tunable Span Unitary Rotational Representation

In this section, the tunable span unitary representation is described in further detail. The Equation (1) shown above may be made more compact by reordering and grouping certain types of rotational matrices. For example, a unitary matrix may be decomposed according to:

$${W}_{N} = D ( {R}_{1 , 2}^{( 1 )} {R}_{3 , 4}^{( 1 )} … {R}_{N / 2 - 1 , N / 2}^{( 1 )} ) \times ( {R}_{2 , 3}^{( 2 )} {R}_{4 , 5}^{( 2 )} … {R}_{N / 2 - 2 , N / 2 - 1}^{( 2 )} ) \times … = {DF}_{A}^{( 1 )} {F}_{B}^{( 2 )} … {F}_{B}^{( L )} ,$$

where every

F_{A}⁽¹⁾=R_{1,2}⁽¹⁾R_{3,4}⁽¹⁾ . . . R_{N/2-1,N/2}⁽¹⁾

is a block diagonal matrix, with N angle parameters in total, and

F_{B}⁽¹⁾=R_{2,3}⁽¹⁾R_{4,5}⁽¹⁾ . . . R_{N/2-2,N/2-1}⁽¹⁾

with N−1 parameters, as is schematically shown in FIG. 2B. By choosing different values for L, W_{N} will span a different subspace of the unitary space of N by N matrices. Specifically, when L=N, W_{N} will span the entire unitary space.

In some embodiments, the tunable span unitary rotational representation involves representing a unitary square weight matrix W (which, in the context of recurrent neural networks is a unitary hidden-to-hidden layer matrix W), as follows:

W=DF_{A}⁽¹⁾F_{B}⁽²⁾F_{A}⁽³⁾F_{B}⁽⁴⁾ . . . F_{B}^{(L)} (Equation 2).

with the definitions of the matrices F provided as above.

Accordingly, in some embodiments, a user may select a particular subspace of the unitary space of N×N matrices by selecting the parameter L. In turn, a unitary rotational representation corresponding to the selected space may be constructed according to Equation (2) above using the selected value of L. Accordingly, the number of parameters in the tunable-span unitary rotational representation of an N×N matrix W is O(NL) parameters. For some tasks, including the tasks described in more detail below, setting L much smaller than N (e.g., L=2, L<10, while N=128 or 512) results in excellent performance, underscoring the flexibility, computational efficiency, and power of this type of unitary rotational representation.

### FFT-Based Rotational Representation

An alternative unitary rotational representation may be obtained by organizing the rotation matrices in a different way. Instead of using adjacent rotation matrices (as is the case in the tunable span unitary rotational representation), an Fast Fourier Transform-based architecture may be employed, whereby each matrix F in Equation (3) below performs a pairwise rotation of coordinates at a certain distance.

W=DF₁F₂F₃F₄ . . . F_{log(N)}. (Equation 3)

In Equation (3), the rotation matrices in Fᵢ are performed between pairs of coordinates

(2pk+j,p(2k+1)+j)

where

$$p = \frac{N}{{2}^{i}} , k ∈ \{ 0 , … , {2}^{i - 1} \}$$

and j∈{1, . . . , p}. This requires only log(N) matrices, so there are a total of N log (N)/2 rotational pairs. This is also the minimal number of rotations that can have all input coordinates interacting with each other, providing an approximation of arbitrary unitary matrices. Accordingly, the number of parameters in FFT-based unitary rotational representation of an N×N matrix W is O(N log N) parameters.

### Efficient Implementation of Rotation Matrices

As discussed above, the unitary rotational representations described herein may be used to implement iterative neural network training algorithms (e.g., backpropagation) in a highly-efficient manner. The computational complexity of iterative neural network training algorithms depends on how much computational and memory resources are required to calculate the gradient for each parameter of the unitary rotational representation employed. Importantly, for both the tunable-span unitary rotational representation and the FFT-based unitary rotational representations described herein, only [symbol] (1) computational and memory access steps are required to calculate the gradient for each parameter, as discussed in more detail below, which means that training neural networks having weight matrices represented via unitary rotational representations may be performed in a computationally efficient manner both from the perspective of processor resources and memory resources.

The inventors have recognized that to implement a unitary rotational representation efficiently, vector element-wise multiplications and permutations may be applied to evaluate the product Fx as follows:

Fx=v₁*x+v₂*permute(x),

where * represents element-wise multiplication. F refers to general rotational matrices such as F_{A/B} in Equation 2 and Fᵢ in Equation 3. For the case of the tunable-span unitary rotational representation, to implement F_{A}⁽¹⁾ in Equation 2, we define v and the permutation as follows:

$${v}_{1} = ( {e}^{i {φ}_{1}^{( 1 )}} cos {θ}_{1}^{( 1 )} , {cos}_{1}^{( 1 )} , {e}^{i {φ}_{2}^{( 1 )}} cos {θ}_{2}^{( 1 )} , cos {θ}_{2}^{( 1 )} , … )$$

$${v}_{2} = ( - {e}^{i {φ}_{1}^{( 1 )}} sin {θ}_{1}^{( 1 )} , sin {θ}_{1}^{( 1 )} , - {e}^{i {φ}_{2}^{( 1 )}} sin {θ}_{2} , sin {θ}_{2}^{( 1 )} , … )$$

$$permute ( x ) = ( {x}_{2} , {x}_{1} , {x}_{4} , {x}_{3} , {x}_{6} , {x}_{5} , … ) .$$

For the FFT-based unitary rotational representation, to implement F₁ in Equation 3, we define v and the permutation as follows:

$${v}_{1} = ( {e}^{i {φ}_{1}^{( 1 )}} cos {θ}_{1}^{( 1 )} , {e}^{i {φ}_{2}^{( 1 )}} cos {θ}_{2}^{( 1 )} , … , cos {θ}_{1}^{( 1 )} , cos {θ}_{2}^{( 1 )} , … )$$

$${v}_{2} = ( - {e}^{i {φ}_{1}^{( 1 )}} sin {θ}_{1}^{( 1 )} , - {e}^{i {φ}_{2}^{( 1 )}} sin {θ}_{2}^{( 1 )} , … , sin {θ}_{1}^{( 1 )} , sin {θ}_{2}^{( 1 )} , … ) . \\ permute ( x ) = ( {X}_{\frac{n}{2} + 1} , {X}_{\frac{n}{3} + 2} … {X}_{n} , {X}_{1} , {X}_{2} … ) .$$

In general, the pseudocode for implementing operation F is shown in Algorithm 1 below.

Algorithm 1 Efficient implementation for
F with parameter θᵢ and ϕᵢ.

Input: input x, size N; parameters θ and ϕ, size N/2; constant
permutation index list indᵢ and ind₂.
Output: output y, size N.
v₁ ← concatenate(cosθ, cosθ*exp(iϕ))
v₂ ← concatenate(sinθ, −sinθ*exp(iϕ))
v₁ ← permute(v₁, ind₁)
v₂ ← permute(v₂, ind₁)
y ← v₁ * x + v₂ * permute (x, ind₂)

Note that the index lists ind₁ and ind₂ are different for different F.

From a computational complexity viewpoint, since the operations * and permutation takes [symbol] (N) computational steps, evaluating Fx only requires [symbol] (N) steps. The product Dx is trivial, consisting of an element-wise vector multiplication. Therefore, the product Wx with the total unitary matrix W can be computed in only [symbol] (NL) steps, and only requires [symbol] (NL) memory access (for full-space implementation L=N, for FFT-style approximation gives L=log N). A detailed comparison on computational complexity of the existing unitary RNN architectures is given in Table 1 below.

Table 1 shows a comparison of computational complexity of four recurrent neural network training algorithms: (1) URNN (partial space unitary recurrent networks); (2) PURNN (projective full-space unitary recurrent neural networks); (3) unitary neural networks using tunable-span unitary rotational representations (EURNN tunable span); and (4) unitary neural networks using FFT-based unitary rotational representations (EURNN FFT based). The variable T denotes the RNN length and N denotes the hidden state size. For the tunable-style EURNN. L is an integer between 1 and N parametrizing the unitary matrix capacity.

| | Time complexity | number of | |
|---|---|---|---|
| | of one online | parameters in the | Transition matrix |
| Model | gradient step | hidden matrix | search space |
| URNN | [symbol] (TN log N) | [symbol] (N) | subspace of U(N) |
| PURNN | [symbol] (TN² + N³) | [symbol] (N²) | full space of U(N) |
| EURNN | [symbol] (TNL) | [symbol] (NL) | tunable subspace |
| (tunable span) | | | of U(N) |
| EURNN | [symbol] (TN log N) | [symbol] (N log N) | subspace of U(N) |
| (FFT based) | | | |

Further details for how forward propagation may be implemented, in some embodiments, is shown in Algorithm 2 below. Further details for how back propagation may be implemented in some embodiments, is shown in Algorithm 3 below.

Algorithm 2 Forward propagation for operation
F with parameter θᵢ and ϕᵢ.

Input: input x, size N; parameters θ and ϕ, size N/2.
Output: output y, size N.
for k = 1 to N/2 do

y_{2k 1} ← x_{2k 1} * (exp(iϕₖ * cos(θₖ) + x₂ₖ * cos(θₖ)
y₂ₖ ← x_{2k 1} * (−exp(iϕₖ * sin(θₖ) + x₂ₖ * sin(θₖ)

end for

Algorithm 3 Back propagation for operation
F with parameter θᵢ and ϕᵢ.

Input: original x, size N; original output y, size N; parameters θ and
ϕ, size N/2; gradient of output dy, size N.
Output: gradient of input dx; gradient of parameters dθ, dϕ.
for k = 1 to N/2 do

dθₖ ← dy_{2k 1} * (− exp(−iϕₖ)) * sin(θₖ) * x_{2k 1} − exp

(−iϕ + k) * cos(θₖ) * x₂ₖ)

```
  dϕₖ ← dy_{2k 1} * i(exp(−iϕₖ)) * cos(θₖ) − exp(iϕₖ)) *
sin(θₖ))
  dx_{2k 1} ← dy_{2k 1} * exp(iϕᵢ * cos(θₖ)) + dy₂ₖ * cos(θₖ)
dx₂ₖ ← dy_{2k 1} * (−exp(iϕₖ * sin(θₖ)) + dy₂ₖ * sin(θₖ)
```

end for

It should be appreciated that any of numerous types of non-linearities may be used with the neural network architectures described herein. For example, the sigmoid, hyperbolic tangent, or rectified linear unit non-linearities may be used. In some embodiments, the following modified rectified nonlinearity may be used:

$${( modRe LU ( z , b ) )}_{i} = \frac{{z}_{i}}{\vert {z}_{i} \vert} * Re LU ( \vert {z}_{i} \vert + {b}_{i} ) ,$$

where the bias vector b is a shared trainable parameter, and |zᵢ| is the norm of the complex number zᵢ. For real number input, mod ReLU may be simplified to:

(mod ReLU(z,b))ᵢ=sign(zᵢ)*ReLU(|zᵢ|+bᵢ)

where |zᵢ| is the absolute value of the real number zᵢ.

As may be seen in the foregoing, the unitary rotational representations described herein are representations of unitary (i.e., square matrices). However, in some instances, adjacent layers of hidden nodes in a neural network may have a different number of nodes. For example, one layer may have N nodes, while the next layer may have M≠N nodes. In such an instance the weight matrix is an N×M rectangular (not square) matrix. However, the techniques described herein may be applied to this situation as well by: (1) estimating weights of an N×N matrix (assuming, without loss of generality, that N>M) using the techniques described herein; and (2) taking an N×M submatrix of the N×N matrix to obtain the weights.

### Example Process

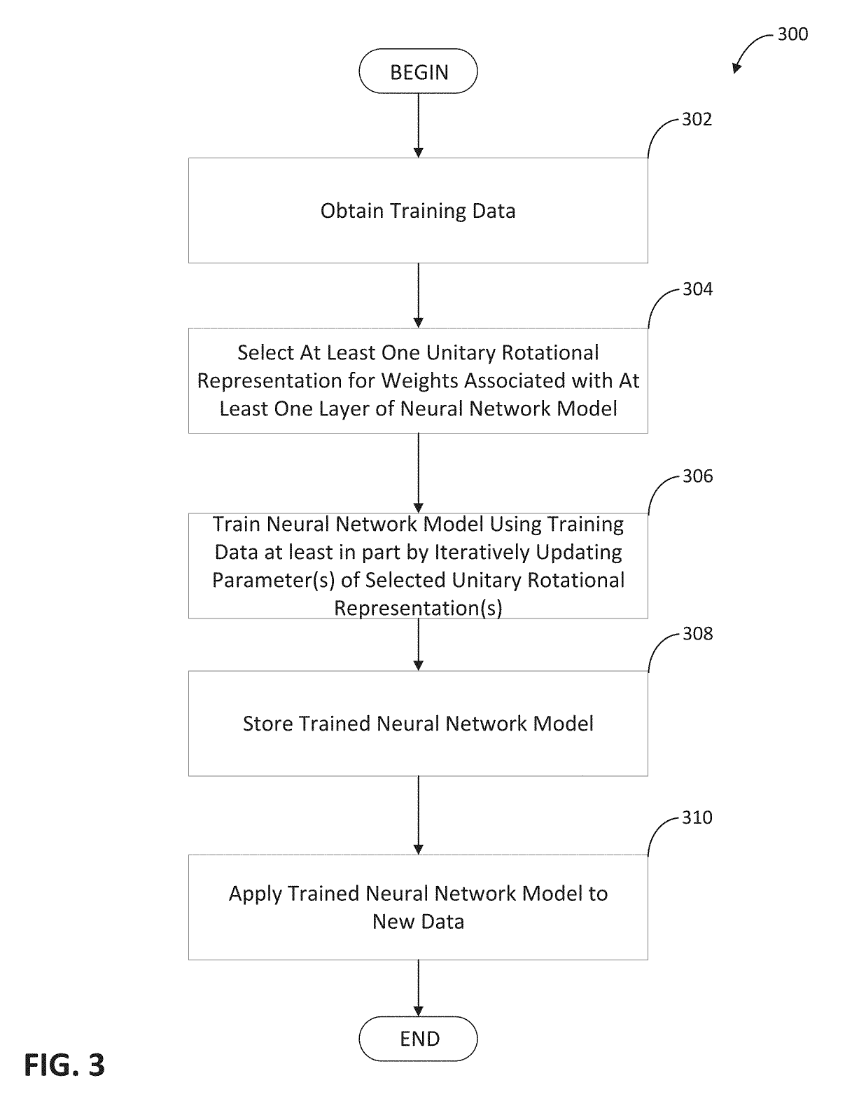

FIG. 3 is a flowchart of an illustrative process 300 for training a neural network model using one or more unitary rotational representations for a respective one or more weight matrices, in accordance with some embodiments of the technology described herein. The neural network model being trained may be a recurrent neural network, a deep neural network, or any other type of neural network whose weights (for each of one or more hidden layers) may be organized in a square weight matrix, which in turn may be represented using any of the unitary rotational representations described herein. Process 300 may be implemented using any suitable computing device(s). For example, process 300 may be implemented using a single computing device or multiple computing devices (e.g., using a cloud-computing environment).

Process 300 begins at act 302, where training data is obtained. The training data will be used for training a neural network model. The training data may be in any suitable format, as aspects of the technology described herein are not limited in this respect. In some embodiments, when the neural network model is being trained to perform a classification task, the training data may include a plurality of training inputs and corresponding class labels.

Next, process 300 proceeds to act 304, where at least one unitary rotational representation is selected for representing a matrix of weights associated with at least one hidden layer of the neural network model. In some embodiments, the neural network model may have a single hidden layer associated with a set of parameters and only a single unitary rotational representation is selected at act 304 (see e.g., the illustrative recurrent neural network shown in FIG. 1). In other embodiments, the neural network model may have multiple hidden layers, each of which may have a corresponding set of weights. In such embodiments, each set of weights may be organized using a weight matrix that may be represented by a respective unitary representation. For example, the neural network model may have a first hidden layer associated with a first set of weights, and a second hidden layer associated with a second set of weights different from the first set of weights. In this example, as part of act 304, a first unitary rotational representation may be selected to represent a first matrix of the first set of weights and a second unitary rotational representation may be selected to represent a second matrix of the second set of weights. The first unitary rotational representation may be parameterized by a first set of angle parameters and the second unitary rotational representation may be parameterized by a second set of angle parameters different from the first set of angle parameters. During training, values for the first and set sets of angle parameters are estimated and, generally, these values will be different.

Regardless of the number of hidden layers, for a given hidden layer, any of the unitary rotational representations described herein may be selected, at act 304, for representing the weights for the given hidden layer. For example, in some embodiments, the tunable-span unitary rotational representation (see e.g., Equation (2)) may be selected. In such embodiments, the span of the rotational representation may be selected first (e.g., the value of the parameter “L” is selected first), and then the corresponding unitary rotational representation may be obtained using Equation (2) and the selected value of “L”. As another example, in some embodiments, the FFT-based unitary rotational representation (see e.g., Equation (3)) may be selected. As yet another example, in some embodiments, a unitary rotational representation corresponding to a different decomposition of the unitary weight matrix may be selected (as described above, the tunable space unitary rotational representation and the FFT-based unitary rotational representation are two examples of how the unitary weight matrix may be decomposed into a product of rotation matrices).

Next, process 300 proceeds to act 306, where the neural network model is trained using the training data obtained at act 302. In some embodiments, the training involves iteratively updating the parameters of the neural network model. The parameters may be updated using gradient descent, stochastic gradient descent, or any other suitable gradient-based iterative optimization algorithm (such algorithms may be used to implement back propagation). Accordingly, as part of act 306, the parameters of the unitary rotational representation(s) selected at act 304 (e.g., the angle parameters of the rotational representations) are iteratively updated at act 306. In some embodiments, the updates may be performed efficiently using element-wise multiplications and permutations as described above (see e.g., Algorithm 1). In some embodiments, back propagation may be implemented as described above with reference to Algorithm 3. Any suitable software package for training neural networks may be used to perform the training including, but not limited to, Theano and Tensorflow (which implement symbolic differentiation).

Next, process 300 proceeds to act 308, where the trained neural network model is stored for subsequent use. This may be done in any suitable way. For example, in some embodiments, the parameters of the trained neural network model (including the parameters of the unitary rotational representations) may be stored using at least one non-transitory computer-readable storage medium.

Next, process 300 proceeds to act 310, where the trained neural network model is applied to new data. To this end, the trained neural network model stored at act 308, may be accessed (e.g., from memory) and used to process new data to obtain a corresponding result. For example, when the neural network model is trained to perform a classification task, the output of the trained neural network model upon processing the new data may be a class label for the new data. It should be appreciated that the neural network model is not limited to being trained for a classification task and, for example, may be trained for a regression task, prediction task, segmentation task, deconvolution task, etc., as aspects of the technology described herein are not limited in this respect. In some embodiments, one or both of acts 308 and 310 may be omitted from process 300—they are optional. In some embodiments, for example when reinforcement learning is used to train the neural network, the result of applying the new data as input to the trained neural network may be used to further update the neural network (e.g., in such embodiments the process may loop from act 310 to act 308).

### Example Implementations

As described above, the techniques described herein may be used to train neural network models for any of a variety of tasks including, but not limited to, image recognition, object recognition, speech processing, natural language processing (and other tasks with high dimensionality and long-term correlations), and optical character recognition. In this section, the results of applying trained neural network models, which are trained in accordance with the training techniques described herein, to different tasks are illustrated and compared with performance of other neural network techniques on the same tasks.

In particular, the performance of efficient unitary recurrent neural networks (EURNN, i.e., recurrent neural networks implemented using a unitary rotational representation in accordance with some embodiments described herein) is compared against the following three conventional neural network models:
1. A long short-term memory recurrent neural network (LSTM RNN);
2. A partial space unitary recurrent neural network (URNN), where weight matrices are represented using diagonal matrices, reflection matrices, a permutation matrix, and Fourier matrices. As discussed above, in this approach, the weight matrices are not represented using a unitary rotational representation.
3. A projective full-space unitary recurrent neural network (PURNN). As discussed above, in this approach, the weight matrices are not represented using a unitary rotational representation. Rather, after a gradient update of the weights, the weight matrix is projected to the space of unitary matrices, which requires N-dimensional matrix multiplication, incurring a prohibitive O(N³) computational cost.

In order to implement the comparisons described below, all of the various types of neural network models (including the models developed by the inventors) were implemented in both Tensorflow and Theano. The EURNN technique developed herein with an [symbol] (N) hidden layer size can compute up to the entire N× N gradient matrix using [symbol] (1) computational steps and memory access per parameter. This is superior to the [symbol] (N) computational complexity of the existing training method for a full-space unitary recurrent neural network (PURNN) and [symbol] (log N) more efficient than the partial space unitary recurrent neural network (URNN) technique.

Copying Memory Task

The techniques developed herein were applied to the “copying task,” which is a well-known synthetic task that is commonly used to test a recurrent neural network model's ability to remember information seen T time steps earlier.

In particular, the task may be defined as follows. An alphabet consists of symbols {aᵢ}, the first n of which represent data, and the remaining two representing “blank” and “start recall”, respectively; as illustrated by the following example where T=20 and M=5:
Input: BACCA---------------------:----
Output: -------------------------BACCA

In the above example, n=3 and {aᵢ}={A, B, C, -, :}. The input consists of M random data symbols (M=5 above) followed by T−1 blanks, the “start recall” symbol and M more blanks. The desired output consists of M+T blanks followed by the data sequence. The cost function C is defined as the cross entropy of the input and output sequences, which vanishes for perfect performance.

In the comparison, we use n=8 and input length M=10. The symbol for each input is represented by an n-dimensional one-hot vector.

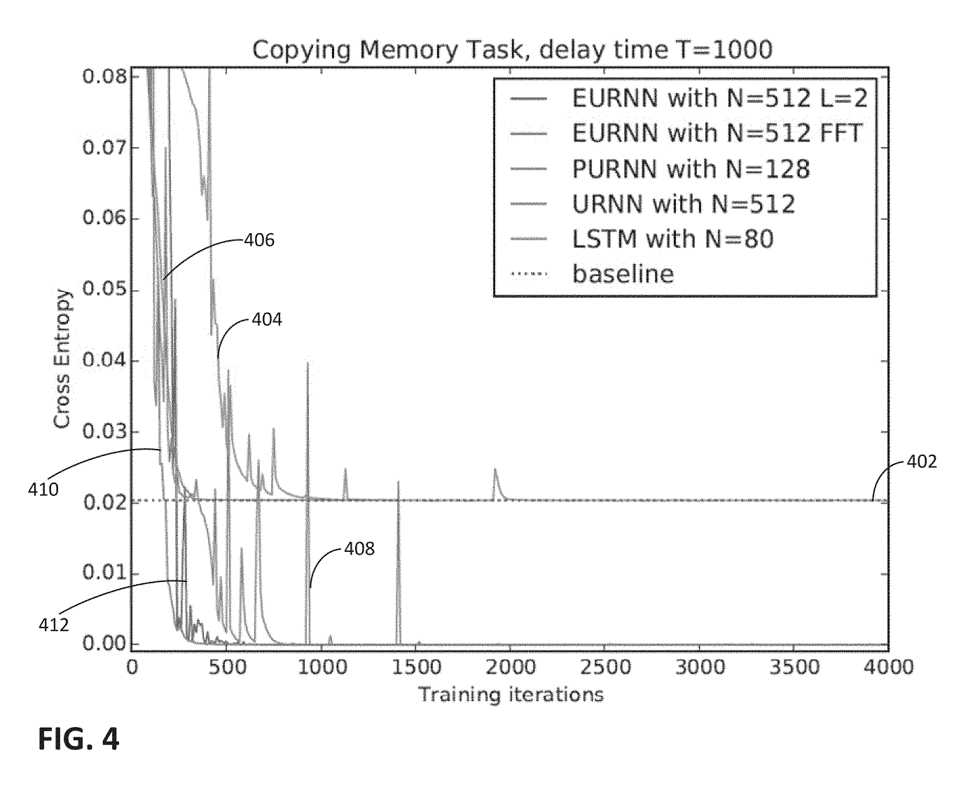

Each of the different types of neural network models discussed above was trained for T=1000, with the same batch size of 128, using RMSProp optimization with a learning rate of 0.001. The decay rate is set to 0.5 for the EURNNs, and 0.9 for all other neural network models respectively. The results are shown in FIG. 4. The baseline performance is shown line 402. Performance of an LSTM model (N=80) is shown with line 404 (it never beats the baseline). Performance of the URNN (N=512) and PURNN (N=128) is shown using liens 406 and 408 respectively. Performance of the FFT-based EURNN (N=512) is shown using line 410. Performance of the tunable span EURNN (L−2) is shown using line 412.

The result shows that the EURNN architectures described herein: (1) a tunable span rotational representation EURNN (with N=512, selecting L−2), and (2) an FFT-based rotational representation EURNN (with N=512) outperform the LSTM model (which suffers from long term memory problems and only performs well on the copy task for small time delays T) and all other RNN models, both in terms of learnability and in terms of convergence rate. Note that the only other unitary RNN model that is able to beat the baseline for T=1000 is the PURNN model, but training this neural network model is significantly slower than training the EURNNs described herein because the PURNN model requires performing expensive projections. In fact, each iteration for PURNN takes about 32 times longer than for EURNN models, for this particular simulation, so the speed advantage is much greater than apparent in this plot.

In addition, it may be observed that by either choosing smaller L (e.g., 1<L<11) in the tunable span rotational representation or by using the FFT-based rotational representation (so that the weight matrix W spans a smaller unitary subspace), the EURNN converges toward optimal performance significantly more efficiently (and also faster in wall clock time) than the URN and PURNN approaches. The EURNN also performed more robustly. This means that a full-capacity unitary matrix is not necessary for this particular task.

Pixel-Permuted MNIST Task

The MNIST handwriting recognition problem is one of the classic benchmarks for quantifying the learning ability of neural networks. MNIST images are formed by a 28×28 grayscale image with a target label between 0 and 9.

To test different recurrent neural network models, all pixels of the MNIST images are fed into the recurrent neural network models in 28×28 time steps, where one pixel at a time is fed in as a floating-point number. A fixed random permutation is applied to the order of input pixels. The output is the probability distribution quantifying the digit prediction. The training was RMSProp with a learning rate of 0.0001 and a decay rate of 0.9, and set the batch size to 128.

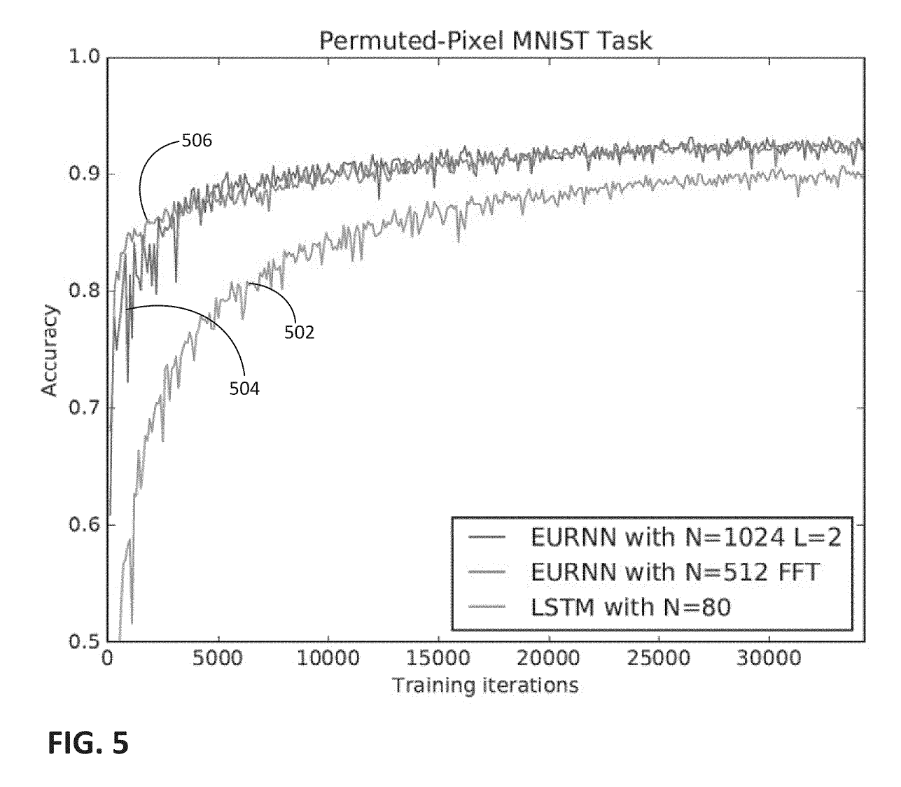

As shown in FIG. 5. EURNN (both tunable-span EURNN, as shown by line 504, and FFT-based EURNN, as shown by line 506) significantly outperforms an LSTM (as shown by line 502) with the same number of parameters. The EURNNs learn faster, in fewer iteration steps, and converge to a higher classification accuracy. In addition, the EURNNs reaches a similar accuracy with fewer parameters. For purposes of comparison. Table 2 shows the performance of different RNN models on the pixel permuted MNIST task.

TABLE 2
Comparison of five different types of recurrent neural networks including
tunable-span EURNN, FFT-based EURNN, LSTM, URNN, and PURNN
on MNIST task

| | hidden size | number of | validation | test |
|---|---|---|---|---|
| Model | (capacity) | parameters | accuracy | accuracy |
| LSTM | 80 | 16k | 0.908 | 0.902 |
| URNN | 512 | 16k | 0.942 | 0.933 |
| PURNN | 116 | 16k | 0.922 | 0.921 |
| EURNN | 1024 (2) | 13.3k | 0.940 | 0.937 |
| (tunable span) | | | | |
| EURNN | 512 (FFT) | 9.0k | 0.928 | 0.925 |
| (FFT based) | | | | |

Speech Prediction on TIMIT Dataset

In addition, the neural network models described herein are applied to a real-world speech prediction task and the performance is compared to that of an LSTM. The main task is predicting the log-magnitudes of future frames of a short-time Fourier transform (STFT) of a speech signal. The speech signals are obtained from the well-known TIMIT data set and downsampled to 8 kHz. The audio .wav file is initially diced into different time frames (all frames have the same duration referring to the Hann analysis window below). The audio amplitude in each frame is then Fourier transformed into the frequency domain. The log-magnitude of the Fourier amplitude is normalized and used as the data for training/testing each recurrent neural network model. In our STFT operation we use a Hann analysis window of 256 samples (32 milliseconds) and a window hop of 128 samples (16 milliseconds). The frame prediction task is as follows: given all the log-magnitudes of STFT frames up to time t, predict the log-magnitude of the STFT frame at time t+1 that has the minimum mean square error (MSE). We use a training set with 2400 utterances, a validation set of 600 utterances and an evaluation set of 1000 utterances. The training, validation, and evaluation sets have distinct speakers. We trained all RNNs for with the same batch size 32 using RMSProp optimization with a learning rate of 0.001, a momentum of 0.9 and a decay rate of 0.1.

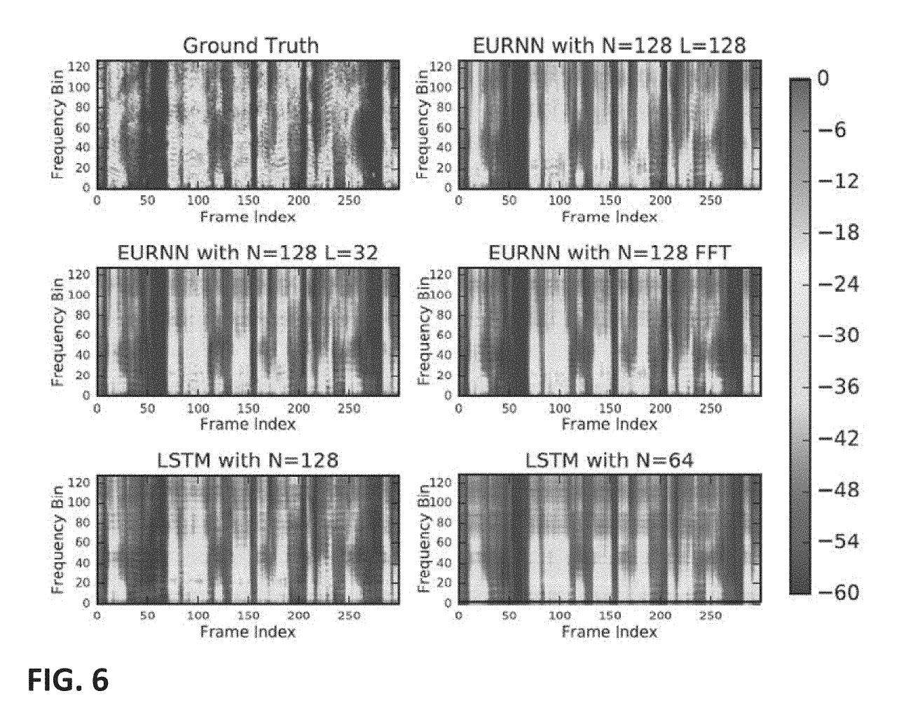

The results are given in Table 3 below, in terms of the mean-squared error (MSE) loss function. FIG. 6 shows prediction examples from the three types of networks, illustrating how EURNNs generally perform better than LSTMs. Furthermore, in this particular task, full-capacity EURNNs outperform small capacity EURNNs and FFT-style EURNNs.

TABLE 3
Speech Prediction task results.

| | hidden size | number of | MSE | MSE |
|---|---|---|---|---|
| Model | (capacity) | parameters | (validation) | (test) |
| LSTM | 64 | 33k | 71.4 | 66.0 |
| LSTM | 128 | 98k | 55.3 | 54.5 |
| EURNN (tunable span) | 128 (2) | 33k | 63.3 | 63.3 |
| EURNN (tunable span) | 128 (32) | 35k | 52.3 | 52.7 |
| EURNN (tunable span) | 128 (128) | 41k | 51.8 | 51.9 |
| EURNN (FFT style) | 128 (FFT) | 34k | 52.3 | 52.4 |

### Additional Implementation Details

As discussed above, the neural network training techniques developed by the inventors may be applied not only to recurrent neural networks, but also to other types of neural networks. In this section, aspects of forward propagation and backpropagation calculations for classification tasks using general neural networks are presented; a derivation for efficient backpropagation is provided. Among other things, further details are provided concerning the complexity of performing gradient calculations during backpropagation when weight matrices are represented using rotational representations, in accordance with some embodiments of the technology described herein.

A general fully connected neural network consists of N hidden layers, and N+1 training matrices {W^{(t)}}s. The forward propagation for any sample x can be described by the following steps:

h⁽⁰⁾=x

z⁽ⁱ⁺¹⁾=W⁽ⁱ⁾·h⁽ⁱ⁾

h⁽ⁱ⁾=σ(z⁽ⁱ⁾)

y=softmax(h^{(N)})

where the softmax function is defined according to;

$$soft {max ( x )}_{p} = \frac{{e}^{{x}_{p}}}{{\sum }_{q = 1}^{K} {e}^{{x}_{q}}}$$

and, the activation function σ(x) may be a sigmoid, hyperbolic tangent, a rectified linear unit (ReLU), or any other suitable nonlinear function.

The cost function may be defined by the cross entropy between h and the labeled classes y:

$$C = {\sum }_{q = 1}^{K} [ \begin{matrix}{y}_{q} log ( {h}_{q} ) & ( \begin{matrix}1 & {y}_{q}\end{matrix} )\end{matrix} log ( \begin{matrix}1 & {h}_{q}\end{matrix} ) ] .$$

In this case, the analytical expression for the gradient

$$\frac{\partial C}{\partial {Θ}^{( i )}} ,$$

where Θ⁽ⁱ⁾ ≡(θ₁₂⁽ⁱ⁾, θₗₘ⁽ⁱ⁾, . . . θ_{(n 1)n}⁽ⁱ⁾), may be calculated as described next.

Nth Layer Neural Network Backpropagation

$$\frac{\partial C}{\partial {θ}_{lm}^{( i )}} = {\sum }_{p}^{ } {\sum }_{q}^{ } \frac{\partial C}{\partial {y}_{p}} \frac{\partial {y}_{p}}{\partial {h}_{p}^{( n )}} \frac{\partial {h}_{p}^{( n )}}{\partial {z}_{p}^{( n )}} \frac{\partial {z}_{p}^{( n )}}{\partial {W}_{pq}^{( n )}} \frac{\partial {W}_{pq}^{( n )}}{\partial {θ}_{lm}^{( n )}} = {\sum }_{p}^{ } {\sum }_{q}^{ } \frac{\partial C}{\partial {y}_{p}} \frac{\partial {y}_{p}}{\partial {h}_{p}^{( n )}} \frac{\partial {h}_{p}^{( n )}}{\partial {z}_{p}^{( n )}} \frac{\partial {W}_{pq}^{( n )}}{\partial {θ}_{lm}^{( n )}} \frac{\partial {z}_{p}^{( n )}}{\partial {W}_{pq}^{( n )}} = {{\to }_{u}}^{( n ) T} \frac{\partial {W}^{( n )}}{\partial {θ}_{lm}^{( n )}} {{\to }_{v}}^{( n )}$$

In the above equation, we have that uₚ⁽ⁿ⁾ is given according to:

$${u}_{p}^{( n )} = \frac{\partial C}{\partial {z}_{p}^{( n )}} = \frac{\partial C}{\partial {y}_{p}} \frac{\partial {y}_{p}}{\partial {h}_{p}^{( n )}} \frac{\partial {h}_{p}^{( n )}}{\partial {z}_{p}^{( n )}} ,$$

which may be computed using O(1) operations and saving \vec{u}⁽ⁿ⁾ cost O(N) memory. Also, in the above equation, we have that \vec{v}⁽ⁿ⁾ is given according to:

\vec{v}⁽ⁿ⁾=\vec{z}^{(n 1)}.

Ith Layer Neural Network Backpropagation

Now, assume that we have computed the gradient matrix for all layers before ith layer, and the vectors \vec{u}⁽ⁱ⁺¹⁾ and \vec{v}⁽ⁱ⁺¹⁾ have been saved. Then, the gradient

$$\frac{\partial C}{\partial {θ}_{lm}^{( i )}}$$

may be computed as follows:

$$\frac{\partial C}{\partial {θ}_{lm}^{( i )}} = {\sum }_{p}^{ } \frac{\partial C}{\partial {z}_{p}^{( i )}} \frac{\partial {z}_{p}^{( i )}}{\partial {θ}_{lm}^{( i )}} = {\sum }_{pq}^{ } \frac{\partial C}{\partial {z}_{p}^{( i )}} \frac{\partial {z}_{p}^{( i )}}{\partial {W}_{pq}^{( i )}} \frac{\partial {W}_{pq}^{( i )}}{\partial {θ}_{lm}^{( i )}} = {\sum }_{pq}^{ } \frac{\partial C}{\partial {z}_{p}^{( i )}} \frac{\partial {W}_{pq}^{( i )}}{\partial {θ}_{lm}^{( i )}} \frac{\partial {z}_{p}^{( i )}}{\partial {W}_{pq}^{( i )}} = {{\to }_{u}}^{( i ) T} \frac{\partial {W}^{( i )}}{\partial {θ}_{lm}^{( i )}} {{\to }_{v}}^{( i )} \\ where \\ {{\to }_{v}}^{( i )} = {{\to }_{z}}^{( \begin{matrix}i & 1\end{matrix} )} .$$

In order to compute \vec{u}⁽ⁱ⁾, we have the following relationships:

$${u}_{p}^{( i )} = \frac{\partial C}{\partial {z}_{p}^{( i )}} = {\sum }_{q}^{ } \frac{\partial C}{\partial {z}_{q}^{( i + 1 )}} \frac{\partial {z}_{q}^{( i + 1 )}}{\partial {z}_{p}^{( i )}}$$

$$Note$$

$$\frac{\partial C}{\partial {z}_{q}^{( i + 1 )}} = {u}_{q}^{( i + 1 )}$$

which is already computed and saved from the previous layer, and

$$\frac{\partial {z}_{q}^{( i + 1 )}}{\partial {z}_{p}^{( i )}} = \frac{\partial {z}_{q}^{( i + 1 )}}{\partial {h}_{p} ( i )} \frac{\partial {h}_{p}^{( i )}}{\partial {z}_{p}^{( i )}} = {W}_{qp}^{( i + 1 )} \frac{\partial {z}_{p}^{( i )}}{\partial {z}_{p}^{( i )}} = {( {W}^{( i + 1 )} )}_{pq}^{T} \frac{\partial σ ( {z}_{p}^{( i )} )}{\partial {z}_{p}^{( i )}}$$

Therefore, from the two above equations, we have

$${{\to }_{u}}^{( i )} = [ {( {W}^{( i + 1 )} )}^{T {\to }_{u} ( i + 1 )} ] ∘ \frac{\partial σ ( {z}^{( i )} )}{\partial {z}^{( i )}}$$

where the final (∘) is the piece-wise (Hadamard) product.

An orthogonal n×n matrix may be generally written as a product of n(n−1)/2 rotation matrices:

W⁽ⁱ⁾=W⁽ⁱ⁾(θ⁽ⁱ⁾)=R₁₂⁽ⁱ⁾R₁₃⁽ⁱ⁾ . . . Rₗₘ⁽ⁱ⁾ . . . R₍ₙ₋₁₎ₙ⁽ⁱ⁾

where Rₗₘ⁽ⁱ⁾=R(θₗₘ⁽ⁱ⁾) is responsible for a rotation in the lm-plane. The rotation angles θₗₘ⁽ⁱ⁾ are our neural network parameters that we try to optimize, keeping the total product matrices W⁽ⁱ⁾ orthogonal for all layers i.

For each layer (i) of the neural network we need to compute the gradient ∂J/∂θₗₘ⁽ⁱ⁾. During the computation, the label (i) stays fixed, so we skip it in the upcoming notation.

$$\frac{\partial J}{\partial {θ}_{12}} = {\to }_{u} ( \frac{\partial W}{\partial {θ}_{12}} ) {\to }_{v} = {\to }_{u} ( {\dot{R}}_{12} {R}_{13} {R}_{14} … {R}_{( \begin{matrix}n & 1\end{matrix} ) n} ) {\to }_{v} = {{\to }_{x}}_{12} \cdot {{\to }_{y}}_{12} .$$

where \vec{x}₁₂≡\vec{u}\dot{R}₁₂ and \vec{y}₁₂≡R₁₃ . . . R_{n(n-1)/2}. The calculation of the vectors \vec{x}₁₂ and \vec{y}₁₂ requires O(n²) computation and O(n) storage (they need to be saved in \vec{x}₁₂≡\vec{x} and \vec{y}₁₂≡\vec{y} and later used), whereas the dot product (the total gradient with respect to θ₁₂) requires O(n) computation. In total, the calculation of the gradient with respect to the first parameter (∂J/∂θ₁₂) requires O(n²) computation. A key aspect of the technology described herein is not having to calculate the gradient for the other O(n) parameters in the same way, as we explain in the following lines. The next gradient that needs to be calculated is

$$\frac{\partial J}{\partial {θ}_{13}} = {\to }_{u} ( {R}_{12} {\dot{R}}_{13} {R}_{14} … {R}_{( \begin{matrix}n & 1\end{matrix} ) n} ) {\to }_{v} = {\to }_{u} ( {\dot{R}}_{12} {\dot{R}}_{12}^{T} {R}_{12} {\dot{R}}_{13} {R}_{13}^{T} {R}_{13} {R}_{14} … {R}_{( \begin{matrix}n & 1\end{matrix} ) n} ) {\to }_{v} = {{\to }_{y}}_{12} ( {\dot{R}}_{12}^{T} {R}_{12} {\dot{R}}_{13} {R}_{13}^{T} ) {{\to }_{y}}_{12} = {{\to }_{x}}_{13} \cdot {y}_{13} . \\ \frac{\partial J}{\partial {θ}_{13}} = {\to }_{u} ( {R}_{12} {\dot{R}}_{13} {R}_{14} … {R}_{( \begin{matrix}n & 1\end{matrix} ) n} ) {\to }_{v}$$

tells us that we can express the gradient with respect to the next parameter by adding a product of 4 rotational matrices and their derivatives (with at most 4 nonzero elements each!!!) between the dot product we had calculated in

$$\frac{\partial J}{\partial {θ}_{12}} = {\to }_{u} ( \frac{\partial W}{\partial {θ}_{12}} ) {\to }_{v} .$$

Namely, we need only O(1) elements in the earlier saved vectors \vec{x}₁₂ and \vec{y}₁₂ and use them to calculate the new \vec{x},\vec{y} and ∂J/∂θ₁₃. The generalization for all parameters is straightforward. Each time, it takes O(1) computation to change the saved vectors and calculate new gradient.

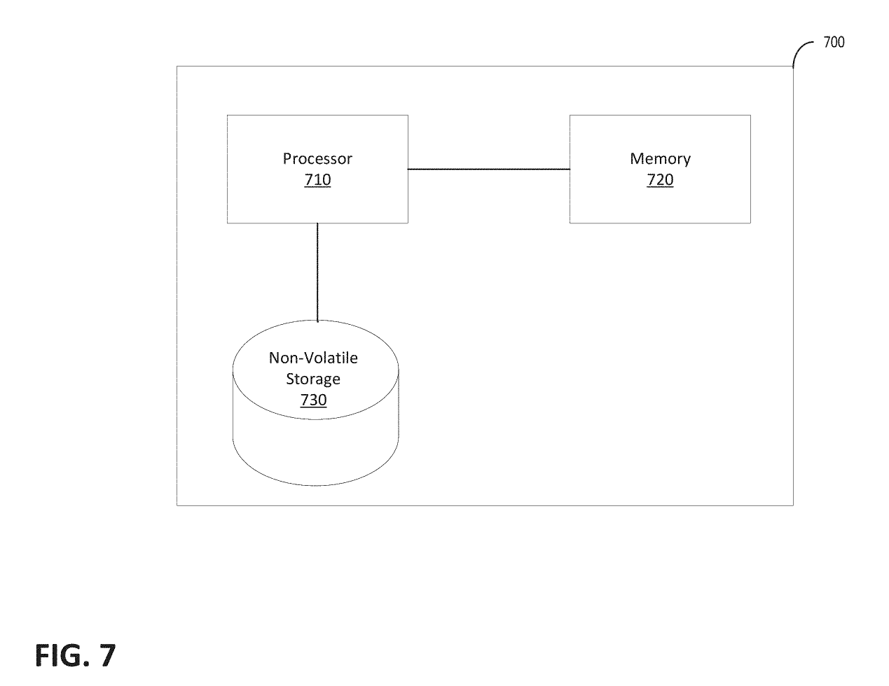

An illustrative implementation of a computer system 700 that may be used in connection with any of the embodiments of the disclosure provided herein is shown in FIG. 7. The computer system 700 may include one or more processors 710 and one or more articles of manufacture that comprise non-transitory computer-readable storage media (e.g., memory 720 and one or more non-volatile storage media 730). The processor 710 may control writing data to and reading data from the memory 720 and the non-volatile storage device 1030 in any suitable manner. To perform any of the functionality described herein, the processor 710 may execute one or more processor-executable instructions stored in one or more non-transitory computer-readable storage media (e.g., the memory 720), which may serve as non-transitory computer-readable storage media storing processor-executable instructions for execution by the processor 710.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein. Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described with reference to FIGS. 2, 9A, and 9B) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one. A, with no B present (and optionally including elements other than B); in another embodiment, to at least one, optionally including more than one. B, with no A present (and optionally including elements other than A); in yet another embodiment, to at least one, optionally including more than one. A, and at least one, optionally including more than one, B (and optionally including other elements); etc.

The phrase “and/or” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising.” “having.” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A system for training a neural network model, the neural network model comprising a plurality of layers including a first hidden layer associated with a first set of weights, the system comprising:
at least one computer hardware processor; and
at least one non-transitory computer-readable storage medium storing processor-executable instructions that, when executed by the at least one computer processor, causes the at least one computer processor to perform:
obtaining training data;
selecting a unitary rotational representation for representing a matrix of the first set weights, the selected unitary rotational representation comprising a plurality of parameters;
training the neural network model using the training data using an iterative neural network training algorithm to obtain a trained neural network model, each iteration of the iterative neural network training algorithm comprising:
updating values of the plurality of parameters in the selected unitary rotational representation for representing the matrix of the set of weights for the at least one hidden layer; and
saving the trained neural network model.

2. The system of claim 1, wherein selecting the unitary rotational representation comprises:
selecting a tunable span unitary rotational representation for representing the matrix of the first set of weights.

3. The system of claim 2, wherein selecting the tunable span unitary rotational representation comprises:
selecting a subspace of the space of unitary matrices; and
obtaining a unitary rotational representation corresponding to the selected subspace.

4. The system of claim 1, wherein selecting the unitary rotational representation comprises:
selecting an FFT-based unitary rotational representation.

5. The system of claim 4, wherein the weight matrix is an N×N matrix and the FFT-based unitary rotational representation comprises a product of log(N) pairwise rotation matrices.

6. The system of claim 1, wherein the neural network model is a recurrent neural network model.

7. The system of claim 1, wherein the neural network model is a deep neural network model.

8. The system of claim 1, wherein the selected unitary rotational representation comprises a product of rotation matrices, and wherein the plurality of parameters comprises angle parameters of the rotation matrices.

9. The system of claim 1, wherein the training data comprises a plurality of training inputs and corresponding class labels, and wherein the processor-executable instructions further cause the at least one computer hardware processor to perform:
obtaining new data not part of the training data;
applying the new data as input to the trained neural network model to obtain corresponding output; and
assigning a class label to the new data based on the corresponding output.

10. The system of claim 1, wherein the plurality of layers includes a second hidden layer associated with a second set of weights different from the first set of weights, wherein the processor-executable instructions further cause the at least one computer hardware processor to perform:
selecting a second unitary rotational representation for representing a matrix of the set of weights, the selected second unitary rotational representation comprising a second plurality of parameters different from the plurality of parameters.

11. A method for training a neural network model, the neural network model comprising a plurality of layers including a first hidden layer associated with a first set of weights, the method comprising:
using at least one computer hardware processor to perform:
obtaining training data;
selecting a unitary rotational representation for representing a matrix of the first set weights, the selected unitary rotational representation comprising a plurality of parameters;
training the neural network model using the training data using an iterative neural network training algorithm to obtain a trained neural network model, each iteration of the iterative neural network training algorithm comprising:
updating values of the plurality of parameters in the selected unitary rotational representation for representing the matrix of the set of weights for the at least one hidden layer; and
saving the trained neural network model.

12. The method of claim 11, wherein selecting the unitary rotational representation comprises:
selecting a tunable span unitary rotational representation for representing the matrix of the first set of weights.

13. The method of claim 12, wherein selecting the tunable span unitary rotational representation comprises:
selecting a subspace of the space of unitary matrices; and
obtaining a unitary rotational representation corresponding to the selected subspace.

14. The method of claim 12, wherein selecting the unitary rotational representation comprises:
selecting an FFT-based unitary rotational representation.

15. The method of claim 11, wherein the neural network model is a recurrent neural network model.

16. The method of claim 11, further comprising:
obtaining new data not part of the training data;
applying the new data as input to the trained neural network model to obtain corresponding output; and
assigning a class label to the new data based on the corresponding output.

17. The method of claim 11, wherein the plurality of layers includes a second hidden layer associated with a second set of weights different from the first set of weights, the method further comprising:
selecting a second unitary rotational representation for representing a matrix of the set of weights, the selected second unitary rotational representation comprising a second plurality of parameters different from the plurality of parameters.

18. At least one non-transitory computer-readable storage medium storing processor-executable instructions that, when executed by at least one computer hardware processor, cause the at least one computer hardware processor to perform a method for training a neural network model, the neural network model comprising a plurality of layers including a first hidden layer associated with a first set of weights, the method comprising:
obtaining training data;
selecting a unitary rotational representation for representing a matrix of the first set weights, the selected unitary rotational representation comprising a plurality of parameters;
training the neural network model using the training data using an iterative neural network training algorithm to obtain a trained neural network model, each iteration of the iterative neural network training algorithm comprising:
updating values of the plurality of parameters in the selected unitary rotational representation for representing the matrix of the set of weights for the at least one hidden layer; and
saving the trained neural network model.

19. The at least one non-transitory computer-readable storage medium of claim 18, wherein selecting the unitary rotational representation comprises:
selecting a tunable span unitary rotational representation for representing the matrix of the first set of weights.

20. The at least one non-transitory computer-readable storage medium of claim 19, wherein selecting the tunable span unitary rotational representation comprises:
selecting a subspace of the space of unitary matrices; and
obtaining a unitary rotational representation corresponding to the selected subspace.
